(19) United States
(12) Patent Application Publication
(10) Pub. No.: US 2019/0143997 A1
(43) Pub. Date: May 16, 2019

(54) AUTOMATED VEHICLE CONFIGURATION

(71) Applicant: Ford Global Technologies, LLC, Dearborn, MI (US)

(72) Inventors: Michael Crimando, Ferndale, MI (US); Enoch Tsai, Ann Arbor, MI (US); Anissa L. Johnson, Irving, TX (US); Andrew John Augusty, Taylor, MI (US); Ameen Basim Al-khafaji, Ypsilanti, MI (US)

(21) Appl. No.: 15/812,427

(22) Filed: Nov. 14, 2017

(51) Int. Cl. B60W 50/00; B60W 10/06; B60W 10/30

(52) U.S. Cl. CPC B60W 50/0098; B60W 10/06; B60W 10/30; B60W 2710/30; B60W 2560/00; B60W 2710/0677; B60W 2540/28

(57) ABSTRACT

A vehicle configuration system includes a controller configured to extract anthropometric information from data defining a vehicle identification number (VIN) for a first vehicle and a customer profile for the first vehicle, and responsive to receiving another VIN for a second vehicle, generate commands such that relative positions of cockpit elements of the second vehicle are adjusted based on the anthropometric information.

### TECHNICAL FIELD

This application is generally related to systems and methods to configure a vehicle based on historical operational data.

### BACKGROUND

A primary goal in the design of automotive vehicle interiors (e.g., vehicle cockpits) is to achieve a comfortable and safe seating position for vehicle occupants in which the occupants may have a wide range of body sizes and types. Many different types of adjustable seat mechanisms are available, and seats in which translation motion, seat back tilt, and seat bolster is powered by electric motors are common. Also, the use of memory seat modules in which multiple preset positions are stored in memory such that a single press of a button will adjust a seat and seat back according to the preset data is common. These adjustments focus on the driver and driver preferences to set seat position such as the seat height, forward/rear position, seat bottom angle, and seat back angle. Typically, limited space is available in the passenger compartments of most vehicles, and particularly in the rear seating rows.

### SUMMARY

A vehicle configuration system includes a controller configured to extract anthropometric information from data defining a vehicle identification number (VIN) for a first vehicle and a customer profile for the first vehicle, and responsive to receiving another VIN for a second vehicle, generate commands such that relative positions of cockpit elements of the second vehicle are adjusted based on the anthropometric information.

A method of configuring a vehicle, by a controller, includes extracting anthropometric information and adjusting relative positions of cockpit elements. The anthropometric information is extracted from data defining a vehicle identification number (VIN) for a remote vehicle and a customer profile for the remote vehicle. The relative positions of cockpit elements of the vehicle are adjusted based on the anthropometric information.

A vehicle includes a powertrain, cockpit elements, and a controller. The controller may be configured to extract anthropometric information from a customer profile that is based on operator data and a vehicle identification number (VIN) of another vehicle, and to adjust settings of the powertrain and relative positions of the elements based on the customer profile and anthropometric information.

### BRIEF DESCRIPTION OF THE DRAWINGS

FIG. 1 is schematic diagram of a vehicle computing system.

FIGS. 2A and 2B are a flow diagram of a vehicle configuration method.

FIG. 3 is flow diagram of a vehicle configuration system.

FIG. 4 is flow diagram of a vehicle configuration system based on historical vehicle data.

FIG. 5 is an illustrative view of data entry via a graphical user interface on a nomadic device.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

When an individual enters into a vehicle show room to consider whether to purchase a vehicle or not, along with a first impression gained from viewing the exterior and interior of the vehicle, the feel of first entering the vehicle may leave a lasting impression. Along with the feel of the cockpit of the vehicle, is the first test drive of the vehicle. During the first test drive, the ergonomics of cockpit configuration can be persuasive in an assessment of the vehicle. For example, the steering wheel tilt, the foot pedal location, the seat position, seat tilt, seat bolster setting, and mirror settings. When an individual goes to a car dealer to test drive a vehicle, the individual provides a form of identification including a state's motor vehicle operator's license (e.g., a driver's license), a country's driver's license, a military ID, or other identification card. Based on the identification card, a system will access a server to obtain a customer preference profile that can be downloaded to a new vehicle to configure multiple vehicle modules. For example, the individual may be associated with a current vehicle such that the vehicle settings for the vehicle can be uploaded to server along with the vehicle identification number (VIN). After being uploaded, the server may abstract preference data associated with the individual (e.g., how they like the cockpit setup). As different vehicles have different cockpit characteristics, the customer preference profile from one vehicle may not be able to be used directly to configure a second vehicle. Here, the customer preference profile is abstracted to create preference data that can be applied to any vehicle based on a weighting or scaling of the data. For example, a pickup truck typically has more cockpit room than a compact car, such that truck leg room is increased by a factor of 1.2 over a standard vehicle and compact car leg room is decreased by a factor of 0.9. The server would read the seat position of the compact car, scale the seat position to compensate for the 0.9 factor and save the result as preference data. If the individual decided that they would like to test drive a pickup truck, the server would receive the VIN of the vehicle and scale the preference data by the pickup truck leg room factor of 1.2 (based on the VIN), download the customer preference profile to the vehicle, and the sever may initiate seat adjustments (translation position, seat back tilt, bolster setting, seat temperature setting, etc.). The server may create the preference data based on anthropometric information and measurements of the individual. Also, the preference data may include radio preset stations, radio volume, foot pedal position, steering wheel tilt and extension, mirror positioning, powertrain calibration data based on historical vehicle usage, transmission shift points, energy efficiency. In one embodiment, the preference data includes a graphical user interface (GUI) of an infotainment system or a vehicle instrument cluster.

The customer preference profile may be determined by different strategies including feedback developed by human participant testing and cabin space calculations based on the optimal seat positions for safety and comfort. For example, human testing can include several individuals of differing physical attributes providing feedback on seat position adjustment preference in different vehicles such that preference data can be extracted after scaling. This feedback can include data such as multiple combinations of occupants having different leg and torso lengths. The data may be based on diverse occupant anthropometric information in which occupants having different anthropometric information are situated in the cockpit. This information can be used to create a look-up table to determine the most likely customer preference profile for the data gathered by the server about the anthropometric characteristics of an expected driver. In another example, data collected from computer models, crash testing or real-world vehicle collision data can be used to create a look-up table of the position most likely to be optimal for safety and comfort. Anthropometric data for an individual (e.g., driver) includes stature (e.g, height), eye to hip distance, shoulder to wrist length, hip to knee length, knee to foot length, shoulder to elbow length, elbow to wrist length, etc.

Thus, when the induvial enters the show room, a system scans the identification card and from the abstracts individual data that is used to cross-reference historical data of a customer preference profile associated with a first vehicle having a first VIN. When the individual initiates a desire to enter a vehicle, a new customer preference profile is created based on the scaled customer preference profile from the first vehicle such that when the individual enters the vehicle, it provides a comfortable fit for the individual. Although a server is described as scaling the data, the scaling may be performed in other computer systems. For example, a nomadic device may be used to download the first customer preference profile from the first vehicle and transmit the first customer preference profile to the second vehicle in which the scaling may be performed by a vehicle controller of the second vehicle.

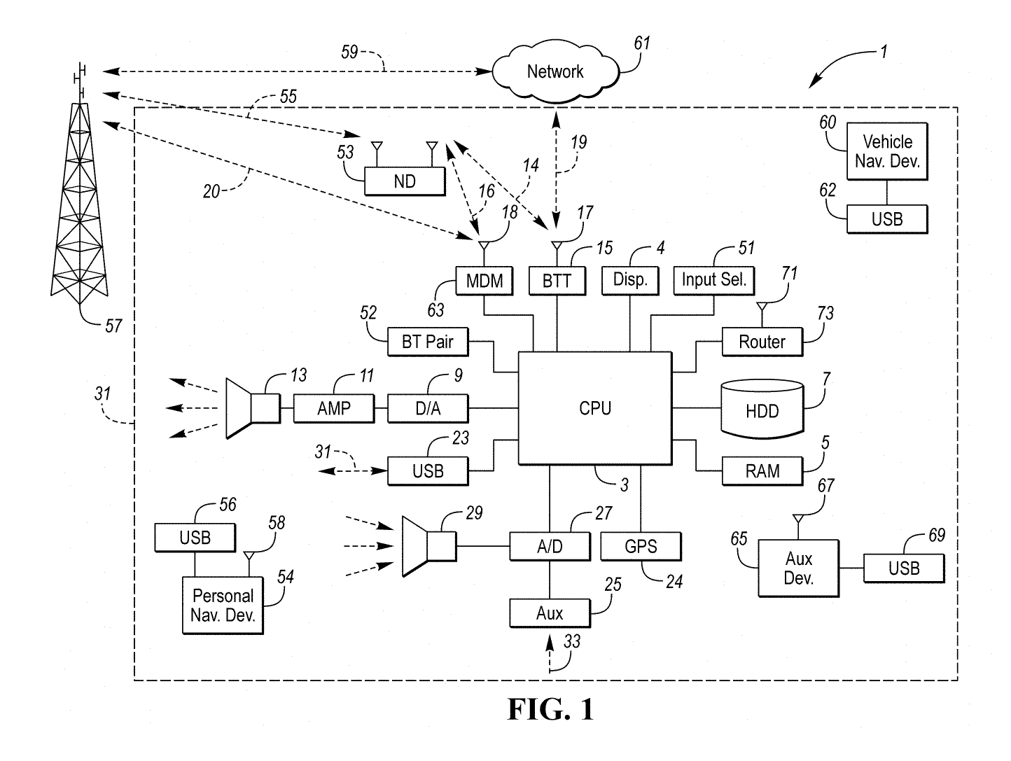

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front-end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11 g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

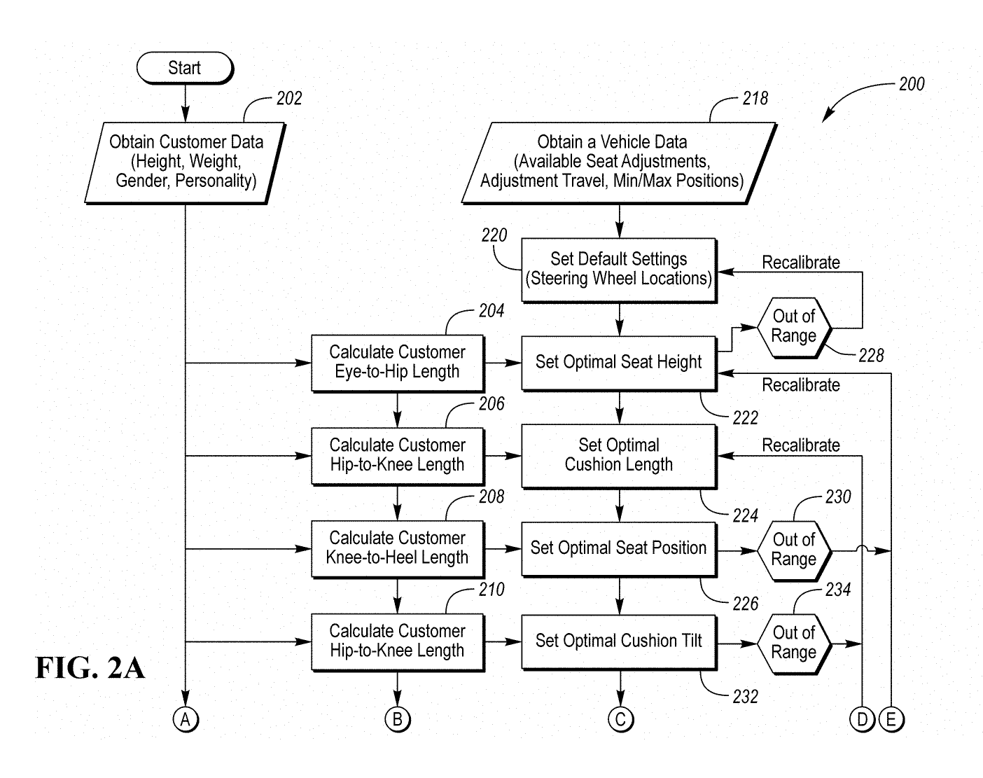

FIGS. 2A and 2B are a flow diagram of a vehicle configuration method 200. In step 202, a controller obtains customer data such as height, weight, gender, personality. The data may be obtained via optical character recognition of an identification card, or responses from a short survey. Based on the customer data, the controller estimates an eye-to-hip length in step 204, estimates a hip-to-knee length in step 206, estimates a knee-to-heal length in step 208, estimates a hip-to-knee length in step 210, estimates a shoulder-to-wrist length in step 212, estimates a height-to-hip length in step 214, and estimates a shoulder-to-hip length in step 216.

Then the controller obtains vehicle data in step 218. The vehicle data includes seat adjustments, foot pedal position, steering wheel tilt and extension, mirror positioning, and historical powertrain operating data. The controller sets a steering wheel location in step 220, a seat height in step 222, a seat cushion length in step 224, a seat translation position in step 226, a seat back tilt in step 232, a steering wheel position and tilt in step 236, a head rest height in step 240. If an intermediate position falls outside of a range of motion for a particular vehicle, the controller will flag an Out of Range in steps 228, 230, 234, 238, or 242 and loop back to recalibrate.

After, the controller will convert the preference data in a customer preference profile that includes seat translation positions, seat back tilt angles, and other actuator position/step sizes in step 244. Then, the controller will transmit the data to the respective controller to adjust the vehicular systems according to the customer preference profile tuned for the current vehicle.

For example, consider a truck having a large cockpit in which the operator is typically in a more vertical position (e.g., seated upright) based vehicle operator data including a side-mirror angle, a seat translation position, a seat back angle, a foot pedal position, steering wheel extension and tilt, etc., anthropometric data may be derived including eye to hip, hip to knee, knee to ankle, shoulder to hip, shoulder to elbow, elbow to wrist length. By obtaining vehicle cockpit setting for a first vehicle and the vehicle VIN that identifies the ergonomic constraints of the vehicle cockpit, and then adapting the vehicle cockpit setting based on the anthropometric data and different ergonomic aspects of a different vehicle identified by a second VIN, vehicle operator data for the second vehicle may be determined based on an adaption of the anthropometric data in the ergonometric constraints of the second vehicle and adjust the second vehicle cockpit according to the adaption. For example, setting moving a foot pedal, a seat translation, a seat back tilt, and a side-mirror angle such that the operator is in a more reclined position in the second car than the first car (i.e., truck) that is ergonomically efficient.

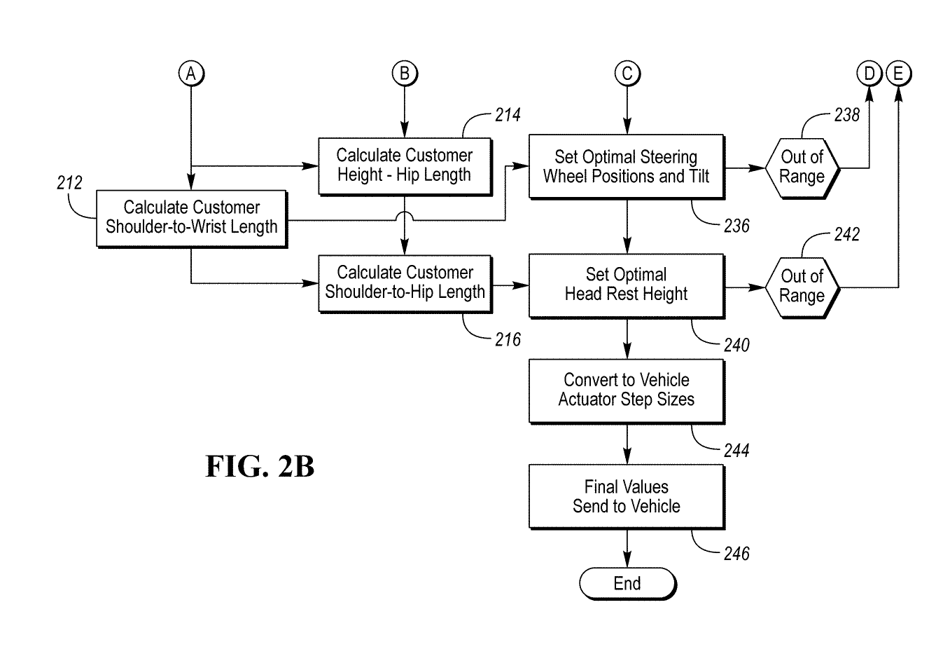

FIG. 3 is flow diagram of a vehicle configuration system 300. Here, a user 302 interacts with a mobile device 304 such as a cell phone, cell phone application, tablet, or other nomadic device. The mobile device 304 receives data such as identification data from an identification card 306, user data input via a survey, or vehicle data read directly from a first vehicle. The data is stored in a database 308 that may be a remote server, memory on the mobile device, or memory in a vehicular computing system. The data is shared with a vehicle 310 via a telecommunication unit (TCU) 312. The TCU 312 parses the data and acts as a gateway to route the appropriate data to the appropriate module. For example, audio presets, GUI layout, other infotainment data is routed to an infotainment system 314, seat translation data, tilt, and bolster data is routed to the seat module 316, heating and cooling preference data is routed to a climate module, powertrain usage, shift-points, and economy data is forward to the powertrain control module 320, and other data (such as power window/side mirror data is sent to adjust a power side mirror in step 322.

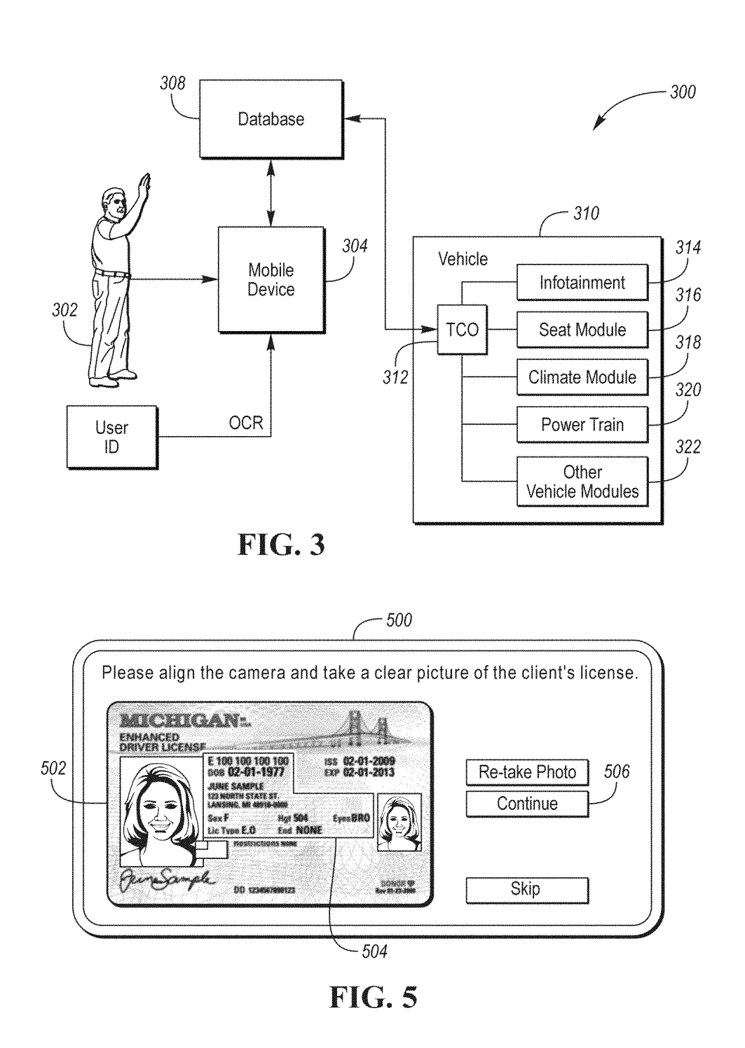

FIG. 4 is flow diagram of a vehicle configuration system based on historical vehicle data. Here, a user 402 interacts with a mobile device 404 such as a cell phone, cell phone application, tablet, or other nomadic device. The mobile device 404 receives data such as identification data from an identification card 406, user data input via a survey, or vehicle data read directly from a first vehicle. The data is stored in a database 408 that may be a remote server, memory on the mobile device, or memory in a vehicular computing system. The data is shared with a vehicle 410 via a telecommunication unit (TCU) 412. The TCU 412 parses the data and acts as a gateway to route the appropriate data to the appropriate module. The TCU 412 forwards comfort and convenience data to comfort and convenience modules 414, and cockpit setting data to cockpit modules 426. The TCU 412 or other controller may parse the data to determine if the individual has previously purchased, leased, or rented sport cars in block 416, if the individual has previously purchased, leased, or rented a sport car, the controller may load a calibration table in the current vehicle to tune the powertrain, transmission for performance in step 418. The controller may also set the infotainment system to adjust a performance package synced with engine RPMs and vehicle speed. Else, the controller proceeds to step 420 in which the controller determines if the individual has previously purchased, leased, or rented a luxury vehicle. If the individual has purchased, leased, or rented a luxury vehicle, the controller may load a calibration table tuned to reduce noise, vibration, and harshness (NVH) within the powertrain, and adjust a suspension for comfort. If the individual has previously purchased, leased, or rented standard sedans, or other vehicles, the controller may load a balanced calibration table in step 424.

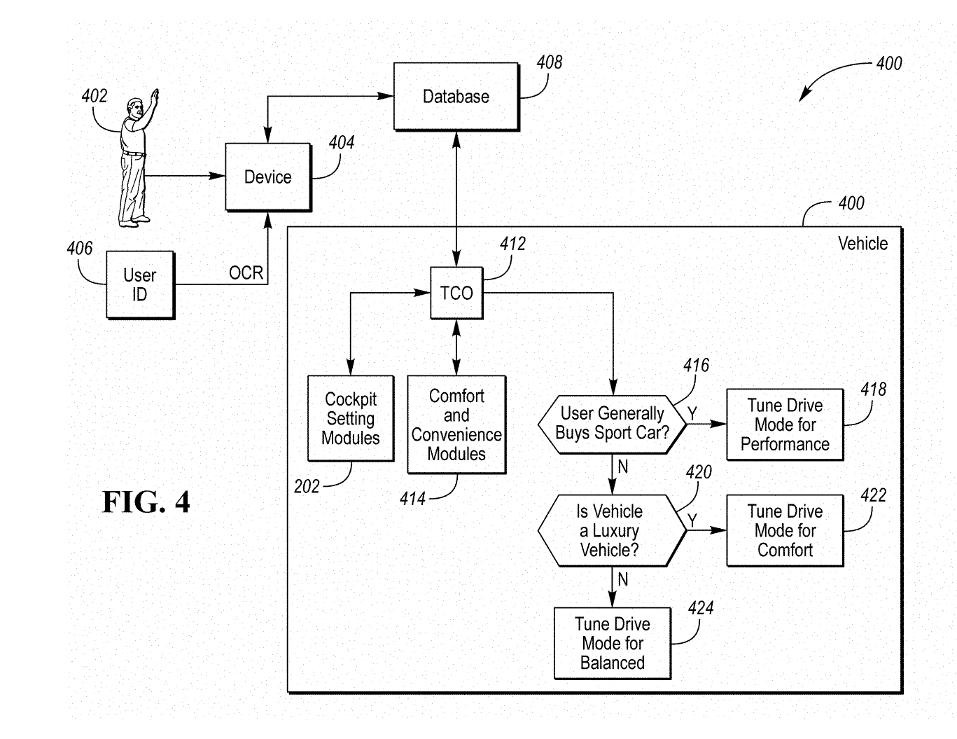

FIG. 5 is an illustrative view of data entry via a graphical user interface (GUI) on a nomadic device. Here, an image of a GUI 500 illustrates a still image of an individual identification card 502 captured by a camera of the nomadic device in which optical character recognition is used to gather data 504 (such as ASCII data) that can be used to search a databased to retrieve an individual customer profile. Once the image is captured, soft-keys 506 may be used to further configure the system. For example, a series of questions may be provided to further tune the customer profile.

Control logic or functions performed by controller may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but are provided for ease of illustration and description. The control logic may be implemented primarily in software executed by a microprocessor-based vehicle, engine, and/or powertrain controller, such as controller. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle configuration system comprising:
a controller configured to extract anthropometric information from data defining a vehicle identification number (VIN) for a first vehicle and a customer profile for the first vehicle, and responsive to receiving another VIN for a second vehicle, generate commands such that relative positions of cockpit elements of the second vehicle are adjusted based on the anthropometric information.

2. The vehicle configuration system of claim 1, wherein the cockpit elements include steering wheel tilt, steering wheel angle, foot pedal, seat translation, seat back angle, a seat bolster setting, or side-mirror angle.

3. The vehicle configuration system of claim 1, wherein the anthropometric information includes an eye to hip length, a hip to knee length, a knee to ankle length, a hip to shoulder length, a shoulder to elbow length, or an elbow to wrist length.

4. The vehicle configuration system of claim 1, wherein adjusting the elements includes changing a seat recline angle and seat translation position relative to a pedal.

5. The vehicle configuration system of claim 1, wherein the data defines an image of a motor vehicle operator's license.

6. The vehicle configuration system of claim 1, wherein the controller is further configured to receive the data from a nomadic device.

7. The vehicle configuration system of claim 1, wherein the controller is further configured to adjust powertrain settings of the second vehicle based on the data.

8. The vehicle configuration system of claim 7, wherein the controller is further configured to adjust suspension settings of the second vehicle based on the data.

9. A method of configuring a vehicle comprising:
by a controller,
extracting anthropometric information from data defining a vehicle identification number (VIN) for a remote vehicle and a customer profile for the remote vehicle, and
adjusting relative positions of cockpit elements of the vehicle based on the anthropometric information.

10. The method of claim 9, wherein the cockpit elements include a seat back and foot pedal.

11. The method of claim 9 further comprising receiving the data from the remote vehicle.

12. The method of claim 9 further comprising receiving the data from a nomadic device.

13. The method of claim 9, wherein the anthropometric information includes an eye to hip length, a hip to knee length, a knee to ankle length, a hip to shoulder length, a shoulder to elbow length, or an elbow to wrist length.

14. A vehicle comprising:
a powertrain;
cockpit elements; and
a controller configured to extract anthropometric information from a customer profile that is based on operator data and a vehicle identification number (VIN) of another vehicle, and to adjust settings of the powertrain and relative positions of the elements based on the customer profile and anthropometric information.

15. The vehicle of claim 14, wherein the controller is further configured to receive the operator data from a nomadic device.

16. The vehicle of claim 14, wherein adjusting the settings includes changing a default shift point, changing a timing calibration table, or changing a maximum engine RPM speed.

17. The vehicle of claim 14, wherein adjusting the relative positions includes changing a seat recline angle and seat translation position.
